(19) United States
(12) Patent Application Publication
(10) Pub. No.: US 2015/0227989 A1
(43) Pub. Date: Aug. 13, 2015

(54) Method and System for Enforcing Acknowledgement of Terms and Conditions

(71) Applicant: Cellco Partnership d/b/a Verizon Wireless, Basking Ridge, NJ (US)

(72) Inventors: Arpita Chattopadhyay, San Jose, CA (US); Tojimon Mathew, Renton, WA (US)

(73) Assignee: Cellco Partnership d/b/a Verizon Wireless, Basking Ridge, NJ (US)

(21) Appl. No.: 14/178,502

(22) Filed: Feb. 12, 2014

(51) Int. Cl. G06Q 30/02; H04L 29/06

(52) U.S. Cl. CPC G06Q 30/0282; H04L 63/083

(57) ABSTRACT

A method and system are disclosed that ensure that customers are aware of and express agreement to the terms and conditions of a service contract before using or managing services associated with their service contract. The present invention may confirm whether a user has accepted the terms and conditions of a service contract independently of validating a user's UserID and password, which may be received when the user attempts to manage the services associated with their service contract.

### FIELD OF THE INVENTION

The field of the present invention relates generally to a method and system for enforcing acknowledgement of terms and conditions in a service contract.

### BACKGROUND

Businesses that offer services to customers typically require their customers to agree to certain terms in an agreement before the customer can use the services offered by the business. The agreement may be a service contract and the terms may be referred to as “terms and conditions” or “terms of use.” Occasionally, customers never actually express agreement to the terms and conditions in the service contract, but nevertheless gain access to the services anyway. When problems arise between the business and the customer with regard to the service contract (e.g., billing issues or improper usage of the services), the service contract and, in particular, the terms and conditions are often referenced in an effort to resolve those problems. If the customer has not actually agreed to the terms and conditions in the service contract, but was nevertheless able to register for services and/or set up a username and password to manage those services, then problems that might arise may be more difficult to resolve and could end up unexpectedly hurting one party to the service contract, or the service contract may be prematurely terminated. The present invention is directed to methods and systems that ensure that customers are aware of and express agreement to the terms and conditions of a service contract before using or managing services associated with their service contract.

### BRIEF DESCRIPTION OF THE DRAWINGS

FIG. 1 depicts a block diagram of a system architecture for sending data through a network, according to an exemplary embodiment;

FIG. 2 depicts a block diagram of a hardware module for gathering data, storing data, validating data, determining whether terms and conditions have been accepted, and outputting data, according to an exemplary embodiment of the invention;

FIG. 3 depicts an exemplary Portal login page, according to an exemplary embodiment of the invention;

FIG. 4 depicts an exemplary welcome email to enable a customer to begin or continue the registration process, according to an exemplary embodiment of the invention;

FIG. 5 depicts an illustrative flowchart of a password reset process, according to an exemplary embodiment of the invention;

FIG. 6 depicts an illustrative flowchart of a process of interaction between a user and a service provider representative, according to an exemplary embodiment of the invention;

FIG. 7 depicts an exemplary password reset email, according to an exemplary embodiment of the invention;

FIG. 8 depicts an illustrative flowchart of a registration process, according to an exemplary embodiment of the invention;

FIG. 9 depicts an illustrative flowchart of a continuation of the registration process, according to an exemplary embodiment of the invention;

FIG. 10 depicts an illustrative flowchart of a login process, according to an exemplary embodiment of the invention.

### DETAILED DESCRIPTION OF THE INVENTION

Reference will now be made in detail to exemplary embodiments, examples of which are illustrated in the accompanying drawings. It should be appreciated that the same reference numbers will be used throughout the drawings to refer to the same or like parts. The following description is intended to convey a thorough understanding of the embodiments described by providing a number of specific embodiments. It should be appreciated that the following detailed descriptions are exemplary and explanatory only and are not restrictive. As used herein, any term in the singular may be interpreted to be in the plural, and alternatively, any term in the plural may be interpreted to be in the singular.

The description below describes modules that may include one or more servers, databases, subsystems and other components. As used herein, the term “module” may be understood to refer to non-transitory executable software, firmware, a processor and/or other hardware, and/or various combinations thereof. Modules, however, are not to be interpreted as software that is not implemented on hardware, firmware, or recorded on a tangible processor-readable or recordable storage medium (i.e., modules are not software per se). The modules are exemplary. The modules may be combined, integrated, separated, and/or duplicated to support various applications and may be centralized or distributed. A function described herein as being performed at a particular module may be performed at one or more other modules and/or by one or more other devices instead of or in addition to the function performed at the particular module. The modules may be implemented across multiple devices and/or other components local or remote to one another. The devices and components that comprise one module may or may not be distinct from the devices and components that comprise other modules.

Embodiments of the system provide the ability to gather data from a user, an apparatus associated with the user, and/or third parties, for the exemplary purpose of obtaining acknowledgement to a set of terms and conditions associated with a service contract.

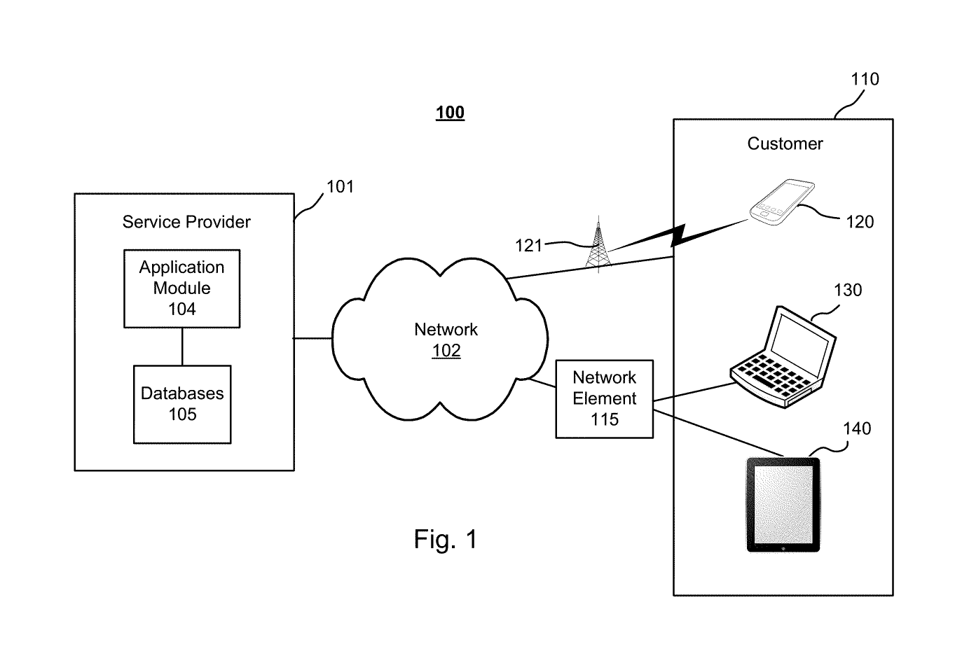

Referring to FIG. 1, a schematic diagram of a system 100 for exchanging data from various sources or devices is shown, according to an exemplary embodiment. As illustrated, network 102 may be communicatively coupled with one or more data transmitting devices or entities, network element 115, or wireless transceiver(s) 121. Exemplary data transmitting devices include a mobile device 120, network client 130, or tablet computer 140, for example. These and other types of data transmitting devices may be communicatively coupled directly with network 102 or via one or more intermediary devices, such as transceiver 121 or network element 115.

It should be appreciated that the system 100 of FIG. 1 may be implemented in a variety of ways. Architecture within system 100 may be implemented as a hardware component (e.g., as a module) within a network element or network box. It should also be appreciated that architecture within system 100 may be implemented in computer executable software (e.g., on a tangible, non-transitory computer-readable medium). Module functionality of architecture within system 100 and even the application module 104 may be located on a single device or distributed across a plurality of devices including one or more centralized servers and one or more mobile units or end user devices.

Network 102 may be a wireless network, a wired network or any combination of wireless network and wired network. For example, network 102 may include one or more of a fiber optics network, a passive optical network, a cable network, an Internet network, a satellite network (e.g., operating in Band C, Band Ku or Band Ka), a wireless LAN, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. In addition, network 102 may include, without limitation, telephone line, fiber optics, IEEE Ethernet 802.3, a wide area network (“WAN”), a local area network (“LAN”), or a global network such as the Internet. Also, network 102 may support an Internet network, a wireless communication network, a cellular network, Bluetooth, or the like, or any combination thereof. Network 102 may further include one, or any number of the exemplary types of networks mentioned above operating as a stand-alone network or in cooperation with each other. Network 102 may utilize one or more protocols of one or more network elements to which it is communicatively coupled. Network 102 may translate to or from other protocols to one or more protocols of network devices. Although network 102 is depicted as one network, it should be appreciated that according to one or more embodiments, network 102 may comprise a plurality of interconnected networks, such as, for example, a service provider network, the Internet, a government network, a cellular network, corporate networks, or home networks.

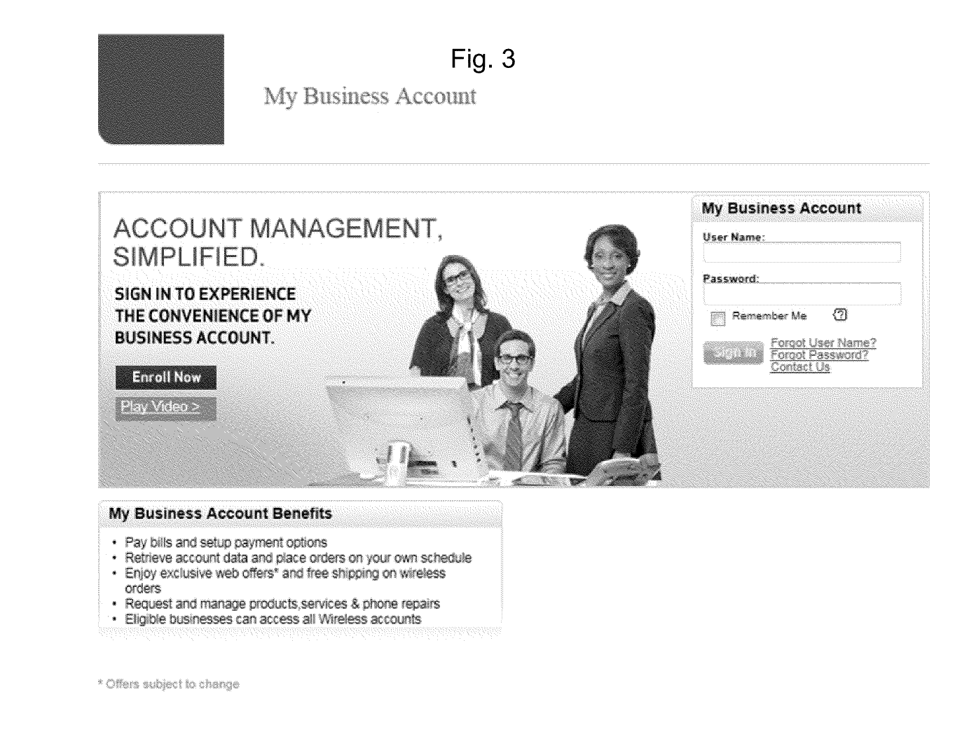

Service provider 101 may communicate with various devices via network 102, transceiver 121, and/or network element 115. Service provider 101 may provide communication and/or data services to the various devices, such as mobile device 120, network client 130, and/or tablet computer 140. For example, mobile device 120, network client 130, or tablet computer 140 may represent a plurality of mobile devices, network clients or tablet computers, respectively, within an entity that has entered a service contract with service provider 101. Using an application module 104, service provider 101 may provide access to its customers to various applications, such as a business portal. As explained in further detail below, the exemplary Portal (a login portion of which is shown in FIG. 3) may allow customers to manage accounts and/or devices that are receiving services under the contract, as explained in further detail below.

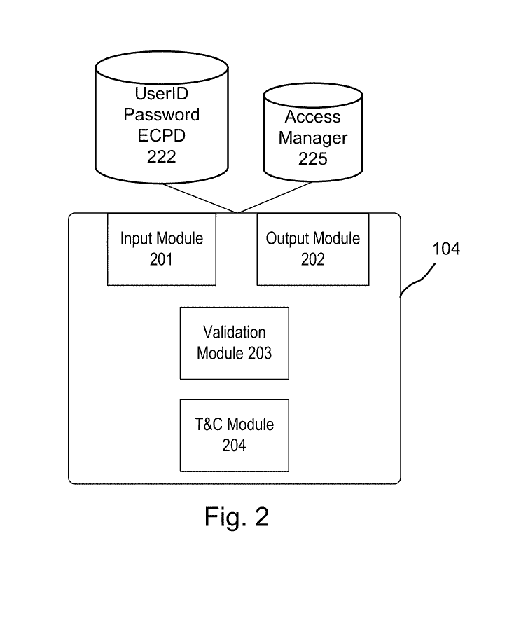

Application module 104 and databases 105 associated with service provider 101 may aid both the service provider and customers in registering and/or using services offered under the service contract. Further details of the application module 104 and databases 105 are provided below with reference to FIG. 2.

Transceiver 121 may be used by service provider 101 to offer services to customers. Transceiver 121 may be a repeater, a microwave antenna, a cellular tower, or another network access device capable of providing connectivity between different network mediums. Transceiver 121 may be capable of sending or receiving signals via a mobile network, a paging network, a cellular network, a satellite network or a radio network. Transceiver 121 may provide connectivity to one or more wired networks and may be capable of receiving signals on one medium such as a wired network and transmitting the received signals on a second medium, such as a wireless network.

Mobile device 120 may be a mobile communications device, a smartphone, a tablet computer, a wearable computer such as in the form of a wrist watch or glasses, a home phone, a cellular phone, a mobile phone, a satellite phone, a personal digital assistant, a computer, a handheld multimedia device, a personal media player, a gaming device, a mobile television, or other devices capable of transmitting data and communicating directly or indirectly with network 102. Mobile device 120, network client 130, and tablet computer 140 may connect to network 102 and communicate with other network elements, servers or providers using a wired connection, WiFi, 3G, 4G, Bluetooth, or other chipsets.

Network client 130 may be a desktop computer, a laptop computer, a tablet, a server, a personal digital assistant, or other computer capable of sending or receiving network signals. Network client 130 may use a wired or wireless connection.

Network element 115, network client 130, tablet 140, or mobile device 120 may include one or more processors (not shown) for transmitting, receiving, or storing data. Data may be transmitted and received via network 102 utilizing a standard telecommunications protocol or a standard networking protocol. For example, one embodiment may utilize Session Initiation Protocol (“SIP”). In other embodiments, the data may be transmitted or received utilizing other Voice Over IP (“VoIP”) or messaging protocols. For example, data may also be transmitted or received using Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

Additionally, it should also be appreciated that system support and updating the various components of the system may be achieved. For example, a system administrator may have access to one or more of the components of the system, network, elements, or devices. It should also be appreciated that the one or more servers, components, elements, or devices of the system may not be limited to physical components. These components may be computer-implemented software-based, virtual, etc. Moreover, the various servers, components, elements, or devices may be customized to perform one or more additional features and functionalities. Such features and functionalities may be provided via deployment, transmitting or installing software or hardware.

It should also be appreciated that each of the communications devices, servers, modules, or network elements may include one or more processors. One or more data storage systems (e.g., databases) may also be coupled to each of the devices or servers of the system. In one embodiment, the one or more data storage systems, such as databases 105, may store relevant information for each of the servers and system components. It should also be appreciated that software may be implemented in one or more computer processors, modules, network components, services, devices, or other similar systems.

Referring to FIG. 2, a block diagram of an exemplary application module 104 is shown, according to an exemplary embodiment. The exemplary application module 104 in FIG. 2 may include an input module 201, an output module 202, validation module 203, T&C (terms and conditions) module 204, and various databases, such as UserID, Password, and ECPD (Enterprise Contract Platform Database) database 222, and Access Manager database 225, each of which is explained further below. Access Manager database 225 may be a SSO (single sign on) database using LDAP (lightweight directory access protocol). Databases 222, 225 may be considered part of the databases 105 of service provider 101 in FIG. 1. Databases 222, 225 may be communicatively connected to application module 104 either directly or via network 102. Databases 222, 225 may be combined into a single database or may represent multiple distinct databases. For example, a UserID database may be separated from a password database to enhance security. Databases 222, 225 may store various information not suggested in the respective names of the databases. For example, UserID database 222 may store known IP address(es) for customers 110.

Input module 201 of application module 104 may receive data from service provider 101 or via network 102 from, for example, customer 110 of the service provider 101 using the various exemplary devices shown in FIG. 1. Data received via input module 201 may be stored in databases 222, 225 and/or in databases 105 of service provider 101.

Output module 202 may retrieve data from databases 222, 225 and/or databases 105, and output such data to service provider 101 or to customer 110 of the service provider 101 via network 102. Output module 202 may provide a graphical user interface (GUI) to an agent of service provider 101 or to a customer 110. The GUI may be in the form of a Portal, which is described in further detail below.

Customer 110 (or potential customer) may enter into a service agreement with service provider 101. The service agreement contains terms that potential customers must agree to before becoming parties to the agreement. For example, service contracts typically contain “terms and conditions” or “terms of use” (hereinafter “terms and conditions” or “T&C”) to elaborate on the expectations of the parties to the service contract and to outline conditions for using services associated with the contract. The terms and conditions may relate to, for example, access to the services by authorized users, access to and use of content provided by the services, addition or cancellation of services, requirements for usage of the services, account information, warranties, limitations of liability, potential disruption of service, changes to the agreement, intellectual property rights, indemnification, confidentiality, choice of law and jurisdiction, etc.

The service provider 101 may enter into service contracts with other businesses, government entities, or individual consumers (collectively, customers 110). When service provider 101 enters into a service contract with a customer 110, for example, the customer 110 gaining access to the services typically delegates a “single point of contact” (“SPOC”) with whom the service provider 101 may coordinate. For example, service provider 101 may offer cellular telephone services to an enterprise-type customer 110 that has several employees. Rather than coordinate with each of the several employees, service provider 101 may coordinate with the SPOC to manage the services and accounts of the several employees. The service provider 101 offering cellular telephone service to customer 110 having several employees is just one example of a service provider, customer, and type of service, but it should be appreciated that the present invention may be applicable to any type of agreement and other types of contractual services and parties (such as small businesses, enterprises, government entities, or individuals, for example). Customer 110 and the “SPOC” associated with customer 110 may be used interchangeably throughout this disclosure. For convenience, the SPOC may handle all billing, service inquiries, upgrades, addition or deletion of accounts, etc., for the several employees of customer 110. Some or all of these may be handled on a web portal offered by service provider 101 (e.g., by application module 104), and the SPOC may be granted access to this portal upon registration. The SPOC may also enter individual service contracts with the service provider 101 on behalf of each of the several employees. Accordingly, the SPOC may be responsible for receiving agreement to the terms and conditions of the services from each of the employees that wish to use those services, and/or the SPOC may be responsible for expressing such agreement to the service provider 101 by agreeing, on behalf of the employee(s) and/or customer 110, to the terms and conditions outlined in the service contract. Acknowledging agreement to the terms and conditions of a service contract may occur, for example, at initiation of the service contract with the customer 110 or upon each new employee account added that is covered by the original or a modified service contract.

Preferably, the SPOC will agree to the terms and conditions prior to usage of the services by any employee of customer 110. The service provider 101 may prefer that registrations or changes to accounts be made using a web portal. The web portal may be beneficial to both customers and the service provider in that the web portal may be a “one-stop-shop” for managing new or existing accounts, for example, and the web portal may also minimize the number of inquiries to the service provider regarding new or existing customer accounts. Service provider 101 may prefer that inquiries go through the web portal because a SPOC working in the web portal may resolve its inquiries without needing to directly contact service provider 101. Customer 110 may use the web portal (hereinafter “Portal”) to identify users eligible for upgrades, activate new devices, suspend lost or stolen devices, place and monitor orders, view spending trends using standard or custom reports to help keep costs in control, access multiple accounts, update contact information, change passwords, review line usage and call details, distribute electronic invoices, change SPOC users or appoint additional authorized “SPOC” users, integrate with third-party systems, access other service provider portals, shop for new devices or solutions, review online-only offers and find exclusive discounts offered by the service provider 101 or other entities working with service provider 101.

The service provider 101 may prefer that customer 110 or the SPOC agree to the terms and conditions before gaining access to the Portal. The SPOC may agree to the terms and conditions when establishing a username and password to access the Portal. An exemplary screenshot of a portal is shown in FIG. 3. Situations may arise where a customer gains access to the Portal without first agreeing to the terms and conditions of the service contract. Exemplary embodiments of the present invention ensure that a customer agrees to the terms and conditions of their service contract before accessing the Portal or using (or setting up) the services associated with the service contract.

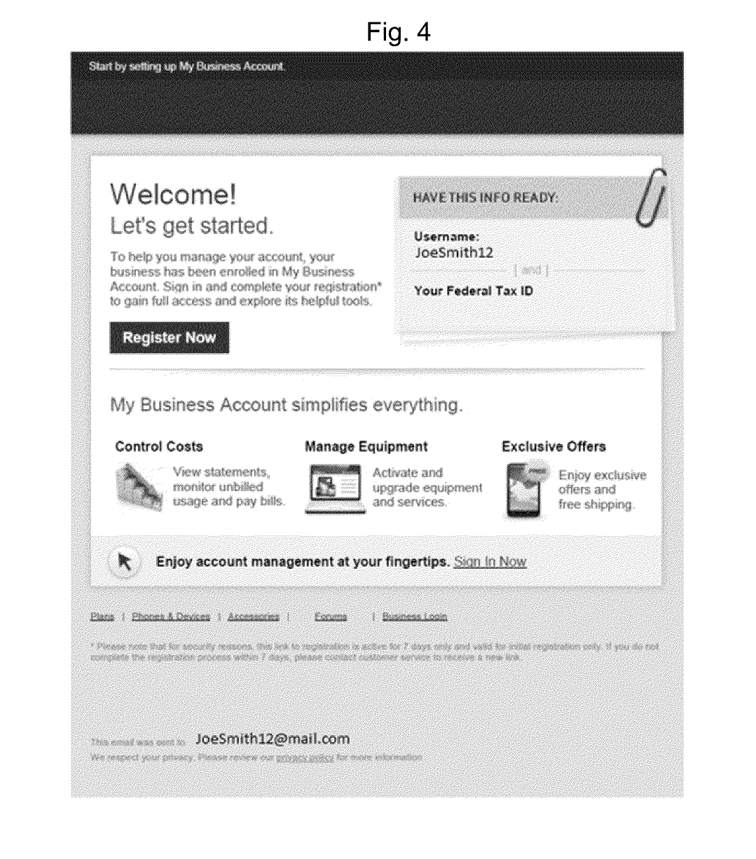

A customer 110 or SPOC that signals a desire to receive service from service provider 101 may receive a confirmation message from output module 202 confirming a desire to register for the service. Customer 110 may signal such a desire by, for example, filling out a web form on a website or otherwise contacting service provider 101. The confirmation message may be in the form of an email and may contain a link to a website (e.g., URL) where the SPOC may complete registration, create a unique password, and/or review and express agreement to the terms and conditions associated with the service contract. An exemplary screenshot of an initial registration email is shown in FIG. 4. As shown in FIG. 4, customer 110 already has a username: “JoeSmith12.” The username may be associated with the “local part” of the customer's email address, which the customer 110 may have provided when signaling a desire to receive service from service provider 101. The username may be another identifier (e.g., company name), and the service provider 101 may already have a record of such identifier because of the initial registration for service by customer 110 or the SPOC. Accordingly, the username may have been previously “created.” After clicking on the “Register Now” link shown in FIG. 3, the SPOC may be directed to a webpage that includes the terms and conditions, and after agreeing to the terms and conditions the SPOC may create a unique password to gain access to the Portal. The username and password may be stored in the UserID and Password database 222, and acknowledgement of agreement to the terms and conditions may be stored in the Access Manager database 225.

Time may pass between the initial registration (or the initial signal of a desire to register) for service and creation of a password to access the Portal to setup and oversee usage of that service. For example, the SPOC may have never completed the registration process by linking to the URL provided in the confirmation email, where the SPOC could have agreed to the terms and conditions and created a unique password. The SPOC may believe that a password has already been created and may attempt to login to the Portal without first completing registration, creating a unique password, and/or accepting the terms and conditions. In such situations, the SPOC may use a “Forgot Password” link on the Portal login page (FIG. 3) and attempt to retrieve a password that has yet to be created. Alternatively, the SPOC may contact the service provider 101 to inquire about a “forgotten” password, or why access to the Portal is not being granted. A representative of the service provider 101 may not appreciate that the SPOC has yet to agree to the terms and conditions of the service contract. Accordingly, the representative may grant temporary access to the Portal or may allow the SPOC to create a “new” password to gain access to the Portal. These are just a couple examples of how a SPOC may gain access to the Portal before agreeing to the terms and conditions associated with the service contract. Accordingly, services may sometimes be setup and used and the SPOC may occasionally oversee usage of those services within the Portal despite the fact that customer 110 has yet to accept the terms and conditions governing those services.

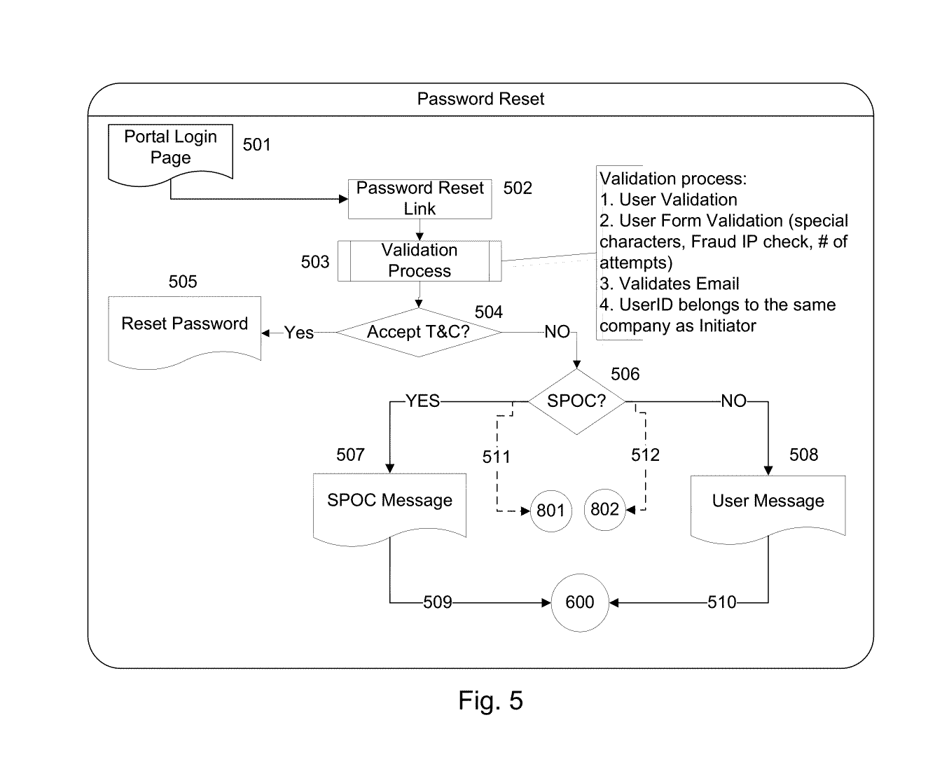

FIG. 5 shows an exemplary flow diagram for a user that clicks on a “Password Reset” link, or a “Forgot Password” link. The link may be on a login page for the Portal (FIG. 3) and the user may be a SPOC user or a non-SPOC user. The process may begin at 501 when the user accesses the Portal Login webpage. At 502, the user may click on the “Password Reset” link, or a “Forgot Password” link on the Portal Login webpage, upon which the user may be prompted to enter their UserID, email address, name, or other contact information. Validation module 203 may perform a validation process at 503, during which various items may be validated, including the user, user form, email address, and/or UserID. For example, the validation module 203 may validate the user by comparing the UserID entered by the user to UserIDs in the UserID database 222 maintained by the service provider 101. UserIDs that do not match a UserID within the UserID database 222 may not be validated. Also, the validation module 203 may determine the IP address from which the user is accessing the Portal or “Forgot Password” webpage and may compare the determined IP address to a known IP address (if known) for the user from a previous login or login attempt. Known IP addresses for customers 110 who have successfully logged in may also be stored in the UserID database 222, indexed by IP address and/or UserID. Users attempting to login from a new IP address may be required to enter additional information to verify their identity. Further, the validation module 203 may monitor the number of login attempts using a particular UserID and/or password to protect against fraudulent attempts to access the Portal. After a number of failed login attempts (for example three), the validation module 203 may lock the account associated with the UserID, and the validation module 203 may direct the user to contact a representative or enter additional security information to unlock their account. The permissible number of failed login attempts may be set by service provider 101, and this number may differ depending on the type of user. For example, a government agency-type customer may have a lower number of permissible failed login attempts than an enterprise-type customer because of potentially more frequent attempts to fraudulently access such an account. This number may also differ based on which organization within an entity/user is attempting to access the account. For example, separate organizations within an entity may have separate accounts with service provider 101, and each separate organization may have its own SPOC, or organizations within an entity may share a SPOC. Some organizations (e.g., a human resources department) within an entity may have a lower number of permissible failed login attempts than other organizations (e.g., an information technology department) within the same entity. Moreover, the additional security information that may need to be entered in order to unlock an account or retrieve a forgotten password may be established by the user during registration. The user may set their own security questions and corresponding answers, and/or service provider 101 may present users with a list of preset questions during registration, and the user may select particular questions to answer and provide the answers. The list of preset questions may differ based on the type of user and/or the organization within an entity. Such questions and answers may be stored in the UserID database 222 and associated with particular UserIDs for later retrieval/verification by validation module 203. Additionally and optionally, validation of data entered into the user form may also occur by analyzing the characters the user entered into the form on the “Forgot Password” webpage. In this manner, validation module 203 may ensure that no special or improper characters (e.g., #, %, &) were entered in particular fields on the form by the user, such as a UserID or email address field.

After the validation module 203 completes the validation process, the terms and conditions module (“T&C module 204”) may determine whether the user has accepted the terms and conditions of the service contract. The T&C module 204 may access a database (e.g., an Access Manager Database 225) which lists the users/UserIDs corresponding to each service contract that have accepted the terms and conditions of the service contract. A determination may be successfully made that the user has accepted the terms and conditions if the Access Manager database 225 lists the user/UserID; and an absence of a particular user/UserID in the Access Manager database 225 may indicate that the user has not yet accepted the terms and conditions. If the T&C module 204 determines that the user has already accepted the terms and conditions, then at 505 output module 202 may output a webpage that enables the user to reset their password by entering a new password. A user that has already accepted the terms and conditions may be considered a SPOC because the responsibility of registering for services and accepting the terms and conditions may lie with the SPOC. If the T&C module 204 determines that the user has not accepted the terms and conditions, or if T&C module 204 is unable to determine whether the user has accepted the terms and conditions, (e.g., unable to access the Access Manager database 225 or incomplete data in database 225 or retrieved from the user) then the process may proceed to 506.

At 506, the validation module 203 may determine whether the user is a SPOC. The validation module 203 may access a database (e.g., an Enterprise Contract Platform Database or ECPD) that lists which users are SPOCs. The ECPD may be part of the UserID database 222, and such database may be indexed by UserID for quick access to the SPOCs associated with each UserID. If the validation module 203 determines that the user is a SPOC, then the process may flow to 507.

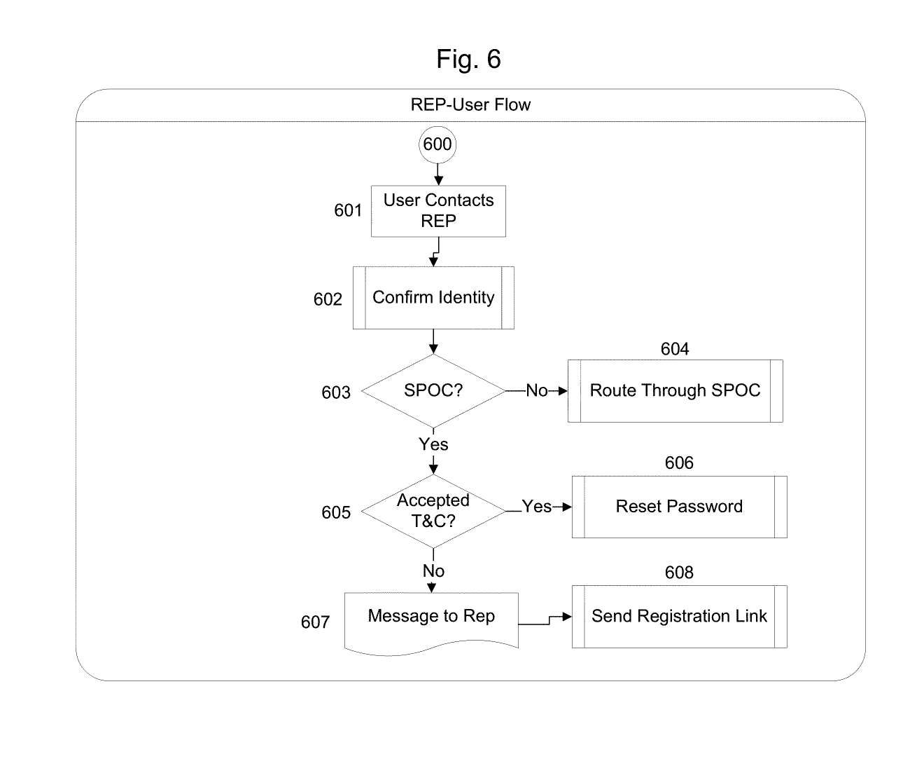

At 507, output module 202 may present the SPOC with a selection of choices to communicate with a representative of the service provider 101. Such choices may include, for example, contact by telephone or computer. In particular, output module 202 may present the SPOC with a message directing the SPOC to call a telephone number (e.g., a toll-free number) or enter a live chat session. Output module 202 may present a telephone number message or live chat window as an overlay to the previous webpage (e.g., as a pop-up window) or as a new webpage. If the SPOC user calls the telephone number or elects to correspond via live chat, the process then proceeds to 509, at which point the SPOC user may communicate with the representative. FIG. 6 shows an exemplary process flow for communications between the representative and the SPOC user.

If the validation module 203 determines at 506 that the user is not a SPOC, then the process may flow to 508. At 508, output module 202 may present the non-SPOC user with a message directing them to have their SPOC call a telephone number (e.g., a toll-free number) or enter a live chat session to communicate with a representative of service provider 101. Similar to above, output module 202 may present a telephone number message or live chat window as an overlay to the previous webpage (e.g., as a pop-up window) or as a new webpage. If the non-SPOC user calls the telephone number or elects to correspond via live chat, the process then proceeds to 510, at which point the non-SPOC user may communicate with the service provider representative. If the non-SPOC user contacts their respective SPOC, who then calls the telephone number or elects to correspond via live chat, the process may still proceed to 510. FIG. 6 shows an exemplary process flow for communications between the service provider representative and the non-SPOC user or SPOC user.

Referring to FIG. 6, an exemplary process flow for communications between a service provider 101 representative and a (non-)SPOC user is shown. The process may begin at 601, at which point the user calls the telephone number or enters the chat session with the service provider 101 representative (“Rep”). At 602, the Rep may obtain and/or confirm the user's identify (e.g., name or username). At 603, the Rep may confirm whether the user is a SPOC or non-SPOC user. This may be accomplished by referring to a database (e.g., an Enterprise Contract Platform Database (ECPD)) that lists SPOC users for each client/customer 110 of service provider 101. If the user is not listed as a SPOC user, then at 604 the output module 202 may present a message to the Rep advising the Rep what to tell the non-SPOC user. For example, the message may instruct the Rep to advise the user to go through the SPOC, or have the SPOC contact a Rep to resolve the issue.

If the user is listed as a SPOC in the ECPD database 222, then at 605 the Rep may confirm whether the SPOC has accepted the terms and conditions of the service contract. This may be accomplished by referring to a database (e.g., an Access Manager Database) that lists which customers 110 have accepted the terms and conditions, or which may more generally list where the SPOC user is in the registration process (for example, the user has expressed a desire to register for service and has provided contact information, but has not accepted the terms and conditions or created a password).

If the Rep confirms and/or records that the SPOC user has not accepted the terms and conditions, then at 607 output module 202 may present a message to the Rep to advise the Rep what to tell the SPOC user. For example, the message may instruct the Rep to advise the SPOC user to restart or continue the registration process and to accept the terms and conditions of the service contract. The Rep may send a message to the SPOC user with details on how to restart or continue the registration process and also provide a copy of, or a link to, the terms and conditions. The message that the Rep sends to the SPOC may comprise an email with a link to restart/continue the registration process, similar to the message shown in FIG. 4. The email or link may also contain the terms and conditions for the SPOC to review, in addition to instructions on how to create or reset their password after accepting the terms and conditions.

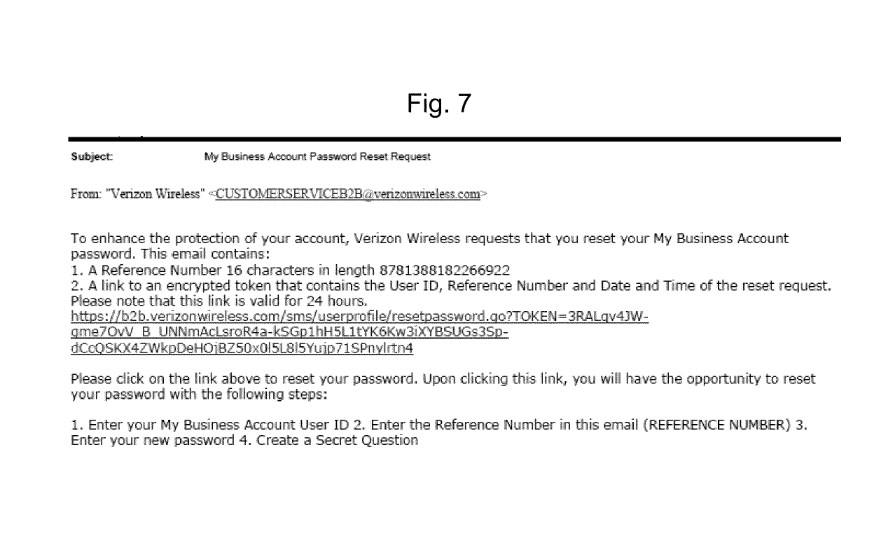

If the Rep confirms and/or records that the SPOC user has accepted the terms and conditions, then at 606 output module 202 may present a message to the Rep to advise the Rep what to tell the SPOC user. For example, the message may instruct the Rep on how the SPOC can reset/create a password, and may also instruct the Rep to send a password message to the SPOC. The Rep may send the password message to the SPOC user with details on how to reset or create a password to enable the SPOC user to login to the Portal. The password message that the Rep sends to the SPOC may comprise an email with a link to a page where the SPOC user can reset/create the password. An exemplary message providing details on how to reset or create a password is shown in FIG. 7.

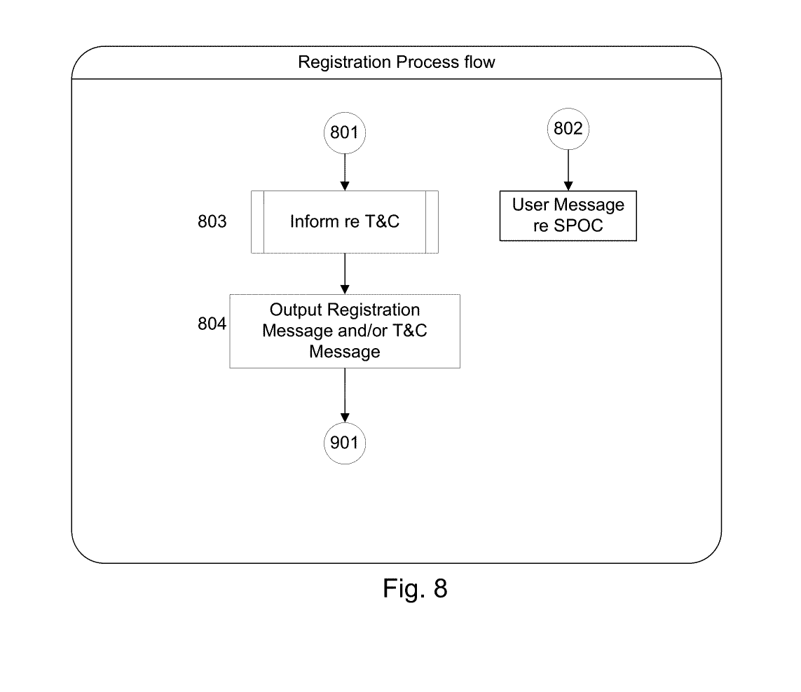

Referring back to FIG. 5, at 506, after a determination is made regarding whether the user is a SPOC, rather than presenting a message to the user directing them to call a telephone number or enter a live chat session to communicate with a representative of the company, application module 104 may direct the user to 801 or 802, depending on whether the user is a SPOC. Referring to FIG. 8, if a determination is made that the user is not a SPOC, then the process may move from 802 to 804. At 804 output module 202 may present a message to the non-SPOC user advising them to go through their SPOC. Optionally, the identity of the SPOC may be revealed to the non-SPOC user to aid the non-SPOC user in contacting the appropriate SPOC. The message presented at 804 may also include a statement regarding what steps to take if the SPOC is unavailable (e.g., no longer with customer 110). Such message may direct the non-SPOC user back to the registration process to register as a SPOC for the business. If the non-SPOC user begins to register as a SPOC user, then the SPOC user already on file for the business (and allegedly unavailable) will be contacted to enhance security.

Alternatively, if a determination is made at 506 that the user is a SPOC, then process may proceed to 801 (FIG. 8). From 801, the process proceeds to 803 and output module 202 may present a message to the SPOC informing them that the reason they cannot access the Portal is that they need to accept the terms and conditions associated with the service contract before they can access the Portal. This message may include instructions on how to restart or continue the registration process and how to accept the terms and conditions of the service contract. The message may comprise a link to restart/continue the registration process. The message may be in the form of an email which contains the link and/or the terms and conditions for the SPOC to review, in addition to instructions on how to create or reset their password after accepting the terms and conditions.

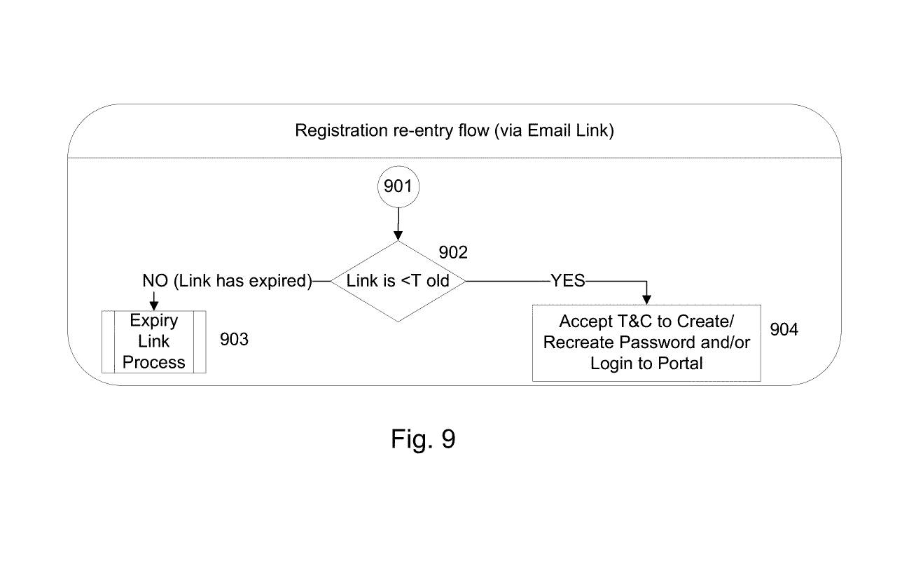

Extra security may be added by tying the link to an expiration date. The expiration date may differ based on the user and/or the entity to which the user belongs. For example, the expiration date may be further in the future for a household user than for an enterprise-type user. As shown in FIG. 9, the link may have a predefined expiry period of “T,” which may be, for example, seven days. If the link is not clicked on or activated within the expiry period, then the link expires and the SPOC user needs to obtain a new link by repeating the process performed to receive the link in the first place. At 901, the user may click on the link. At 902, the application module 104 may determine whether the link has expired. If the application module 104 determines that the link has expired, then at 903 a message may be provided to the user on what to do to receive a new (unexpired) link. The message may explain that the link has expired.

Alternatively, if the application module 104 determines that the link has not expired, then the SPOC may be led to a page where they can review and accept the terms and conditions, and then reset or create a password associated with their UserID. Thereafter, the SPOC may use this UserID and password to login to the Portal.

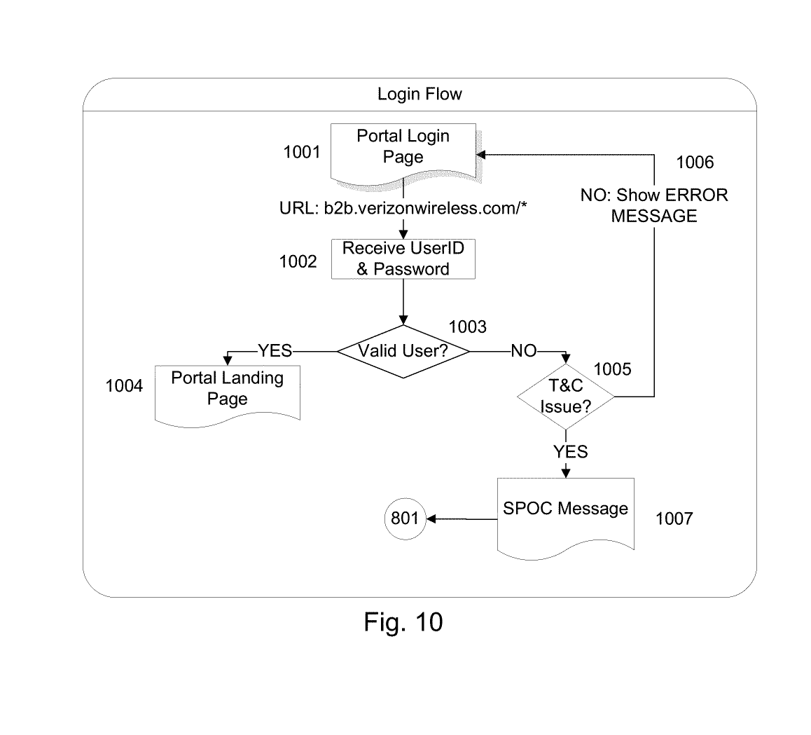

FIG. 10 shows an exemplary flow diagram for logging into the Portal. At 1001, the user may access the Portal login page by entering the address for the portal (e.g., b2b.verizonwireless.com/*). At 1002, input module may receive the UserID and password from the user. At 1003, validation module may perform a validation process similar to that described above. Validation module 203 may determine, for example, (1) whether the UserID matches a UserID on record with the company, (2) whether the password matches the UserID, (3) whether the user is active (e.g., has the user logged in to the portal within the past 30 days, for example), and/or (4) whether the user has accepted the terms and conditions associated with their service contract. A user may be designated as “active” or “inactive” using a timer that expires after a period of days set by the service provider 101 (e.g., 30 to 90 days), such that upon expiration the user may be designated as “inactive.” The timer may be reset each time the user logs into the Portal, thereby allowing the user to retain an “active” designation. The designation of active/inactive for each particular user may be stored in the UserID database 222, and such data may be retrieved or referenced by validation module 203, for example.

To validate the UserID and password, validation module 203 may compare the UserID and password entered by the user to entries in the UserID and password database 222 maintained by the service provider 101. UserIDs and/or passwords that do not match a UserID within the UserID database 222 may not be validated. In such a case, a generic message may be presented to the user indicating that the UserID and/or password do not match records of the service provider.

The validation module 203 may also determine whether the user is active. The times and locations of previous logins (either successful or unsuccessful) may be recorded in the UserID and password database 222. If the user has not logged into the Portal for a predetermined period of time (e.g., 1 month), then the user may be required to answer additional security questions (e.g., questions previously answered by the user during registration) and/or agree to the terms and conditions associated with the service contract again.

Also at 1003, the T&C module 204 may determine whether the user has accepted the terms and conditions of the service contract. The T&C module 204 may access a database (e.g., an Access Manager Database 225) which lists the users/UserIDs corresponding to each service contract that have accepted the current terms and conditions of the service contract. Even if the UserID and password combination matches a UserID and password combination on record with the service provider, access may not be granted if the current terms and conditions of the service contract have not been accepted. Additionally, if service provider 101 modifies the terms and conditions associated with the service contract, then the T&C module 204 may automatically require users to accept the modified terms and conditions before logging into the Portal. Thus, whether or not the terms and conditions of the service contract have changed, even if the user previously managed to login without accepting the terms and conditions of the service contract, in attempting to login again an automatic determination may be made as to whether the user has accepted the terms and conditions of the service contract. Consequently, the user may be required to accept the terms and conditions of the service contract prior to access.

Similar to that explained above with respect to FIG. 5, the validation module 203 may determine the IP address from which the user is accessing the Portal and compare the determined IP address to a known IP address for the user from previous successful logins. Known IP addresses for customers 110 may be stored in the UserID database 222. Users attempting to login from a new IP address may be required to enter additional information to verify their identity, such as entering answers to secret questions previously answered by the user during the registration process. Validation module 203 may also monitor the number of login attempts using a particular UserID and/or password to protect against fraudulent attempts to access the Portal. After a number of failed login attempts (for example three), the validation module 203 may lock the account associated with the UserID, and the validation module 203 may direct the user to contact a representative or enter additional security information to unlock their account.

If the validation module 203 and T&C module 204 determine that the user is a valid user, then at 1004 the user may be directed to the Portal home page (e.g., the Portal Landing Page). If either the validation module 202 or the T&C module 204 determines that the user is not a valid user, then at 1005 the system may determine whether the user is not valid because they have not accepted the terms and conditions associated with their service contract (a “T&C issue”). If the user is not valid because of a non-T&C issue, or is not valid because of an issue in addition to a T&C issue, then at 1006 output module 202 may present a message to the user instructing the user that an error has occurred. The error message may be a generic error message so as to not give too much information to a potentially fraudulent user that would aid such a user in attempts to bypass the error. If the user is not valid solely because of a “T&C issue,” then at 1007 output module 203 may present a message to the SPOC indicating that the SPOC has not yet accepted the terms and conditions associated with their service contract. This may occur, for example, if the terms and conditions have been modified by the service provider 101 and the user has not accepted the modified terms and conditions, or if the user was somehow able to get a UserID and password without previously accepting the terms and conditions. After presenting the message at 1007, the process may proceed to 801. The process may continue from 801 to 804 as explained above, such that the user is directed to accept the terms and conditions before gaining access to the Portal.

With the various embodiments described above, a customer 110 may be prevented from accessing a Portal where they can setup and manage services received by the service provider 101. In this manner, a service provider 101 may ensure that customers 110 are aware of and express agreement to the terms and conditions of a service contract before using services associated with their service contract. Accordingly, problems that may have arisen if the customer (or user on behalf of the customer) had not actually agreed to the terms and conditions in the service contract may be avoided. By automatically checking whether the terms and conditions have been accepted upon each login attempt by a user, the potential problems of using services without accepting the terms and conditions of those services may be avoided. Moreover, by confirming whether a user has accepted the terms and conditions (or an updated version of those terms and conditions), independently of validating a user's UserID and password, the present invention is able to enforce user acknowledgement of the terms and conditions associated with their service contract. Thus, even if a registration process is prematurely terminated, or a user is able to set up a UserID and password, or a user was previously able to use and manage services provided by a service provider, without agreeing to the terms and conditions associated with those services, the present invention effectively ensures that users agree to their respective terms and conditions before managing the services associated with their service contract.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

While the foregoing illustrates and describes exemplary embodiments of this invention, it is to be understood that the invention is not limited to the construction disclosed herein. The invention can be embodied in other specific forms without departing from the spirit or essential attributes.

What is claimed is:

1. A method comprising:
outputting, by an output module, a web portal for access by a user related to a customer, the web portal allowing the user to manage usage of services provided by a service provider to the customer, the services being governed by terms and conditions;
receiving, by an input module, a request from the user to retrieve or create a password;
validating, by a validation module, the user by comparing information supplied by the user to information stored in relation to the services;
determining, by a terms and conditions module, whether the user has accepted the terms and conditions associated with usage of the services; and
based on a determination that the user has accepted the terms and conditions associated with usage of the services, outputting, by the output module, instructions to the user on how to retrieve or create the password.

2. The method of claim 1, wherein the customer is a corporate entity and the user manages the services used by the corporate entity, the method further comprising determining whether the user is a single point of contact for the customer.

3. The method of claim 1, wherein upon a determination that the customer has not accepted the terms, outputting, via the output module, a message to the user that the terms and conditions must be agreed to before the user can log in to the web portal.

4. The method of claim 3, wherein the message is in the form of an email, the email including a link to a URL where the user can accept the terms and conditions on behalf of the customer.

5. The method of claim 4, further comprising determining whether the URL has been accessed by the user using the link within a predefined period of time.

6. The method of claim 4, further comprising receiving from the user, by the input module, agreement to the terms and conditions on behalf of the customer.

7. The method of claim 6, after receiving agreement to the terms and conditions, receiving the password created by the user and storing the created password in a database.

8. A non-transitory computer readable medium comprising code to perform the acts of the method of claim 1.

9. A method comprising:
outputting, by an output module, a web portal for access by a user related to a customer, the web portal allowing the user to manage usage of services provided by a service provider to the customer, wherein usage of the services are governed by terms and conditions;
receiving, by an input module, a userID and password from the user;
validating, by a validation module, the user using the received userID and password;
determining, by a terms and conditions module, whether the user has accepted the terms and conditions associated with usage of the services; and
based on a determination that the user has not accepted the terms and conditions associated with usage of the services, outputting, by the output module, a message to the user that the terms and conditions must be agreed to before the user can log in to the web portal.

10. The method of claim 9, wherein the message includes a link to a URL where the user can accept the terms and conditions on behalf of the customer.

11. The method of claim 10, further comprising receiving from the user, by the input module, agreement to the terms and conditions on behalf of the customer.

12. The method of claim 11, further comprising after receiving agreement to the terms and conditions, again receiving the userID and password from the user.

13. The method of claim 12, further comprising granting access to the web portal to the user.

14. A system comprising:
a processor; and
a memory comprising computer-readable instructions which when executed by the processor cause the processor to perform the steps comprising:
outputting a web portal for access by a user related to a customer, the web portal allowing the user to manage usage of services provided by a service provider to the customer, the services being governed by terms and conditions;
receiving a request from the user to retrieve or create a password;
validating the user by comparing information supplied by the user to information stored in relation to the services;
determining whether the user has accepted the terms and conditions associated with usage of the services; and
based on a determination that the user has accepted the terms and conditions associated with usage of the services, outputting instructions to the user on how to retrieve or create the password.

15. The system of claim 14, wherein the instructions further cause the processor to determine whether the user is a single point of contact for the customer.

16. The system of claim 14, wherein the instructions further cause the processor, upon a determination that the customer has not accepted the terms and conditions, to output a message to the user that the terms and conditions must be agreed to before the user can log in to the web portal.

17. The system of claim 16, wherein the message is in the form of an email, the email including a link to a URL where the user can accept the terms and conditions on behalf of the customer.

18. The system of claim 17, wherein the instructions further cause the processor to receive acknowledgement from the user of agreement to the terms and conditions on behalf of the customer and the password created by the user.
